(19) United States
(12) Patent Application Publication
(10) Pub. No.: US 2026/0342099 A1
(43) Pub. Date: Oct. 29, 2026

(54) SYSTEMS AND METHODS FOR OPERATING INVERTER-BASED RESOURCES USING INTERLEAVING PULSE PATTERNS

(71) Applicant: General Electric Renovables España, S.L., Barcelona (ES)

(72) Inventor: Einar Vaughn Larsen, Ballston Lake, NY (US)

(21) Appl. No.: 19/099,216

(22) PCT Filed: Jul. 29, 2022
(86) PCT No.: PCT/US2022/038822

§ 371 Date: Jan. 28, 2025

(51) Int. Cl. H02J 3/38; F03D 7/04; H02J 3/01; H02J 101/28; H02M 1/00; H02M 7/483; H02M 7/5395

(52) U.S. Cl. CPC H02J 3/381; F03D 7/048; H02J 3/01; H02M 1/0043; H02M 7/483; H02M 7/5395; H02J 2101/28

(57) ABSTRACT

A method for operating a plurality of inverter-based resources (IBRs) connected to an electrical grid at a point of common coupling (PCC) includes providing pulse patterns for at least two of the IBRs to respective local controllers of the at least two IBRs. The method also includes receiving, via the respective local controllers, one or more measured electrical signals from the electrical grid. Further, the method includes establishing, via the respective local controllers, a timing reference for interleaving the pulse patterns for the at least two IBRs based on the one or more measured electrical signals from the electrical grid. In addition, the method includes operating the at least two IBRs in parallel on the electrical grid via the respective local controllers utilizing the pulse patterns and the timing reference such that the pulse patterns are interleaved with each other to reduce a voltage distortion at the PCC.

### FIELD

The present disclosure relates generally relates to inverter-based resources, and more particularly to interleaving pulse patterns for inverter-based resources, such as wind turbines.

### BACKGROUND

Modern wind turbines are commonly used to supply electricity into the electrical grid. Wind turbines of this kind generally include a tower and a rotor arranged on the tower. The rotor, which typically includes a hub and a plurality of rotor blades, is set into rotation under the influence of the wind acting on the rotor blades. Such rotation generates a torque that is normally transmitted through a rotor shaft to a generator, either directly or through a gearbox. The generator produces electricity which can be supplied to the electrical grid. The hub may be rotatably coupled to a front of a nacelle. Further, the hub may be connected to a rotor shaft, and the rotor shaft may then be rotatably mounted in the nacelle using one or more rotor shaft bearings arranged in a frame inside the nacelle. The nacelle is a housing arranged on top of the tower that contains and protects e.g., the gearbox (if present) and the generator and, depending on the wind turbine, further components such as a power converter and/or auxiliary systems.

Wind turbines are often grouped together in “wind farms”, which generally refer to a common geographical location having a plurality of wind turbines. These wind turbines may be connected to a local (internal) electrical grid of the wind farm. The internal grid of the wind farm may include a plurality of strings, and a number of wind turbines can be connected to each of these strings. The electrical grid of the wind farm may be connected to a main power grid at a point of common coupling (PCC).

A trend in the field of wind turbines is to place the wind turbines in offshore wind farms. Offshore wind farms may be connected to a mainland electrical grid through a high voltage transmission line, e.g., a High Voltage Alternating Current (HVAC) transmission or a High Voltage 30 Direct Current (HVDC) transmission.

The wind turbines may supply power to the internal wind farm grid at a voltage of e.g., 33 kilovolts (kV) or 66 kV. At a substation, the voltage may be stepped up to several hundred kV with high voltage transformer(s). The high voltage electrical power may then be supplied to a high voltage transmission line connected to the mainland grid. The substation may also include e.g., circuit breakers, surge arresters, capacitor banks and other.

As with most renewable energy sources, wind turbines generally include power-electronic conversion to regulate the power injected to the electric grid. These power conversion systems include an inverter that creates some energy at other than the nominal grid frequency, typically described as harmonics. This is a fundamental characteristic of all inverter-based resources (IBRs). As more and more IBRs connect to the electric power grid, the combined effect of their individual harmonics can become significant. The impact is greatly amplified by the unavoidable resonances within the electric power network.

A well-known and very effective means to mitigate the effect of IBR harmonics is to include damping filters on the power grid. However, such filters can be costly or impractical in some instances, e.g., for offshore wind farms.

Thus, conventional methods of mitigating harmonics is by refining the control algorithms of the IBR converters in a way that minimizes the impact on grid voltage distortion. However, due to the large amplification associated with grid resonances, minimizing harmonics from an individual IBR may be insufficient to provide effective mitigation.

To overcome this inherent constraint, methods of interleaving the converter controls of groups of IBRs within a facility have been proposed, e.g., as taught by EP2209200B1, entitled “Electrical System and Control Method” filed on Aug. 12, 2009. Such prior-art methods, however, rely on communication between the controllers of the various IBRs to enable the desired interleaving. This communication requirement can be problematic since it must establish a precise timing reference that all IBRs in the group reference to ensure effective interleaving.

Accordingly, the present disclosure is generally directed to systems and methods of operating a pair IBRs using interleaving pulse patterns without the need for communication between their respective individual controllers.

### BRIEF DESCRIPTION

Aspects and advantages of the invention will be set forth in part in the following description, or may be obvious from the description, or may be learned through practice of the invention.

In an aspect, the present disclosure is directed to a method for operating a plurality of inverter-based resources connected to an electrical grid at a point of common coupling. The method includes providing pulse patterns for at least two of the plurality of inverter-based resources to respective local controllers of the at least two of the plurality of inverter-based resources. The method also includes receiving, via the respective local controllers, one or more measured electrical signals from the electrical grid. Further, the method includes establishing, via the respective local controllers, a timing reference for interleaving the pulse patterns for at least two of the plurality of inverter-based resources based on the one or more measured electrical signals from the electrical grid. In addition, the method includes operating the at least two of the plurality of inverter-based resources in parallel on the electrical grid via the respective local controllers utilizing the pulse patterns and the timing reference such that the pulse patterns are interleaved with each other to reduce a voltage distortion at the point of common coupling.

In another aspect, the present disclosure is directed to a wind farm connected to an electrical grid. The wind farm includes a plurality of wind turbines connected in parallel to the electrical grid at a point of common coupling and a plurality of local controllers. Each of the plurality of wind turbines are controlled by one of the plurality of local controllers. Each of the plurality of local controllers includes a pulse pattern programmed therein. The plurality of local controllers configured to perform one or more operations. The operation(s) include, but are not limited to receiving one or more measured electrical signals from the electrical grid, establishing a timing reference for interleaving the pulse patterns for at least two of the wind turbines based on the one or more measured electrical signals from the electrical grid, and operating the at least two of the wind turbines in parallel on the electrical grid utilizing the pulse patterns and the timing reference such that the pulse patterns are interleaved with each other to reduce a voltage distortion at the point of common coupling.

In yet another aspect, the present disclosure is directed to a method for operating a plurality of inverter-based resources connected to an electrical grid at a point of common coupling. The method includes determining a pulse pattern for each of the plurality of inverter-based resources. Further, the method includes receiving, via respective local controllers of the plurality of inverter-based resources, one or more measured voltage signals from the electrical grid. Moreover, the method includes establishing, via the respective local controllers, a timing reference for interleaving the pulse patterns for the plurality of inverter-based resources based on the one or more measured voltage signals. In addition, the method includes operating, via the respective local controllers, the plurality of inverter-based resources in parallel on the electrical grid utilizing the pulse patterns and the timing reference such that pairs of the pulse patterns of the plurality of inverter-based resources are interleaved together to reduce a voltage distortion at the point of common coupling.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a schematic view of an embodiment of a full power conversion system suitable for use with the wind turbine shown in FIG. 1;

FIG. 3 illustrates a schematic view of an embodiment of an individual inverter suitable for use with the full power conversion system shown in FIG. 2;

FIG. 4 illustrates the nature of voltage at the AC side of an inverter of the full power conversion system of FIG. 3, which is the result of the gating control used with that inverter;

FIG. 5 illustrates a schematic diagram of an embodiment of an example of an offshore wind farm according to the present disclosure;

FIG. 6 illustrates a flow diagram of an embodiment of a method for operating a plurality of inverter-based resources connected to an electrical grid at a point of common coupling according to the present disclosure;

FIG. 7 illustrates a schematic view of an embodiment of a string of inverter-based resources according to the present disclosure; and

FIG. 8 illustrates a flow diagram of another embodiment of a method for operating a plurality of inverter-based resources connected to an electrical grid at a point of common coupling according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment.

Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Generally, the present disclosure is directed to systems and methods for operating at least two inverter-based resources in parallel on an electric grid. More particularly, on each inverter-based resource, the present disclosure utilizes timing information derived from the locally-sensed grid voltage such that harmonic currents from the group approximately cancel. Accordingly, in embodiment, converter pulse patterns can be designed such that selected harmonics have a combination of magnitude and phase with respect to the fundamental-frequency voltage that a net effect of those selected harmonics cancel when the group is operating on the electrical grid. In an embodiment, for example, a group of at least two inverter-based resources may have two different pulse patterns selected at commissioning. The characteristic of the pulse patterns may have, for example, the same amplitude of a selected harmonic, however, the phase angle may be shifted by 180 degrees with respect to each other. Since the grid voltages provides the means of maintaining the two inverter-based resources performing the desired interleaving function, the respective local controllers of the two inverter-based resources can operate independently of each other to establish the timing reference for interleaving the pulse patterns and utilize only the one or more measured electrical signals without communicating to each other.

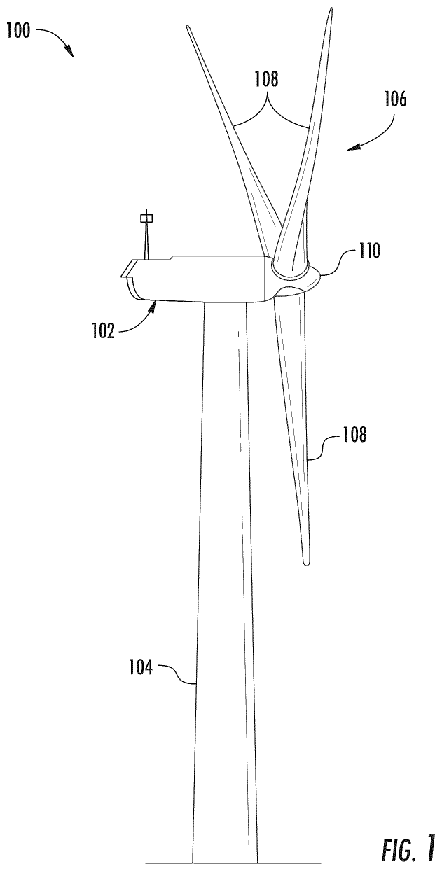

Referring now to the drawings, FIG. 1 illustrates a perspective view of a portion of an inverter-based resource, such as a wind turbine 100. The wind turbine 100 includes a nacelle 102 housing a generator (not shown in FIG. 1). The nacelle 102 is mounted on a tower 104 (a portion of tower 104 being shown in FIG. 1). The tower 104 may have any suitable height that facilitates operation of wind turbine 100 as described herein. The wind turbine 100 also includes a rotor 106 that includes a plurality of rotor blades 108 attached to a rotating hub 110, such as three rotor blades 108. Alternatively, the wind turbine 100 may include any number of rotor blades 108 that facilitates operation of the wind turbine 100 as described herein. In an embodiment, the wind turbine 100 may also include a gearbox (not shown in FIG. 1) operatively coupled to rotor 106 and a generator (not shown in FIG. 1).

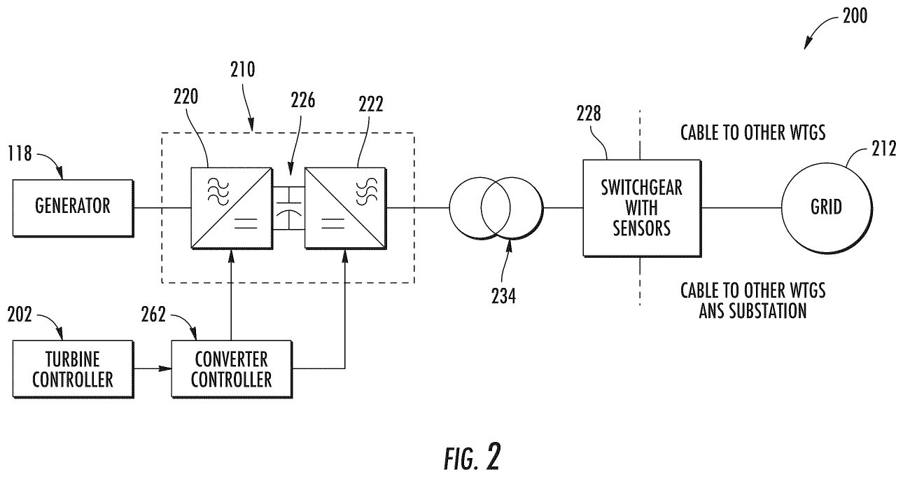

Referring now to FIG. 2, a schematic view of an embodiment of a full power conversion system 200 that may be used with wind turbine 100 is illustrated in accordance with the present disclosure. Thus, in an embodiment, as shown, the power conversion system 200 is configured for supplying power to an electrical grid 212.

In addition, as shown, the power conversion system 200 may include a three-phase power converter system. More specifically, as shown, the power conversion system 200 includes a generator 118 coupled to a power conversion assembly 210. The power conversion assembly 210 includes a generator-side power converter 220 for AC-DC conversion electrically coupled to a line-side power converter 222 for DC-AC conversion. Further, as shown, the generator-side power converter 220 is coupled to the line-side power converter 222 via a single direct current (DC) link 226. In addition, as shown, the power conversion system 200 further includes a main transformer 234 electrically coupled between the power conversion assembly 210 and the electrical grid 212.

Accordingly, the DC power is transmitted from the DC link 226 to the line-side power converter 222 and the line-side power converter 222 acts as an inverter configured to convert the DC electrical power from DC link 226 to three-phase, sinusoidal AC electrical power with pre-determined voltages, currents, and frequencies. This conversion is monitored and controlled via a converter controller 262. The power conversion assembly 210 compensates or adjusts the frequency of the three-phase power from generator 118 for changes, for example, in the wind speed at the hub 110 and the rotor blades 108.

Moreover, in an embodiment, as shown, the power conversion system 200 may include a switchgear assembly 228 having one or more sensors coupled between the main transformers 234 and the grid 212. Thus, in such embodiments, the switchgear assembly 228 connects the power conversion system 200 into a string of other wind turbine generators (e.g., WTGs). Furthermore, in such embodiments, the sensor(s) of the switchgear assembly 228 are configured to detect voltage and/or current flows, which can be used by the converter controller 262 as described herein.

Referring still to FIG. 2, the power conversion system 200 may also be coupled in electronic data communication with a turbine controller 202 and/or a converter controller 262 to control the operation thereof. For example, in an embodiment, the converter controller 262 is configured to receive control signals from turbine controller 202. The control signals are based on sensed conditions or operating characteristics of wind turbine 100 and the power conversion system 200.

The control signals are received by the turbine controller 202 and used to control operation of power conversion assembly 210. Feedback from one or more sensors may be used by the power conversion system 200 to control power conversion assembly 210 via the converter controller 262.

The turbine controller 202 and/or the converter controller 262 include at least one processor and a memory, at least one processor input channel, at least one processor output channel, and may include at least one computer. As used herein, the term computer is not limited to integrated circuits referred to in the art as a computer, but broadly refers to a processor, a microcontroller, a microcomputer, a programmable logic controller (PLC), an application specific integrated circuit, and other programmable circuits, and these terms are used interchangeably herein. In the exemplary embodiment, memory may include, but is not limited to, a computer-readable medium, such as a random access memory (RAM). Alternatively, one or more storage devices, such as a floppy disk, a compact disc read only memory (CD-ROM), a magneto-optical disk (MOD), and/or a digital versatile disc (DVD) may also be used. Also, in the exemplary embodiment, additional input channels (not shown in FIG. 2) may be, but are not limited to, computer peripherals associated with an operator interface such as a mouse and a keyboard. Further, in the exemplary embodiment, additional output channels may include, but are not limited to, an operator interface monitor (not shown in FIG. 2).

Processors for the turbine controller 202 and/or the converter controller 262 process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

The converter controller 262 is substantially similar to turbine controller 202 and is coupled in electronic data communication with turbine controller 202, as generally shown in FIG. 2. Moreover, in the exemplary embodiment, the converter controller 262 is physically integrated within power conversion assembly 210. Alternatively, the converter controller 262 has any configuration that facilitates operation of power conversion system 200 as described herein.

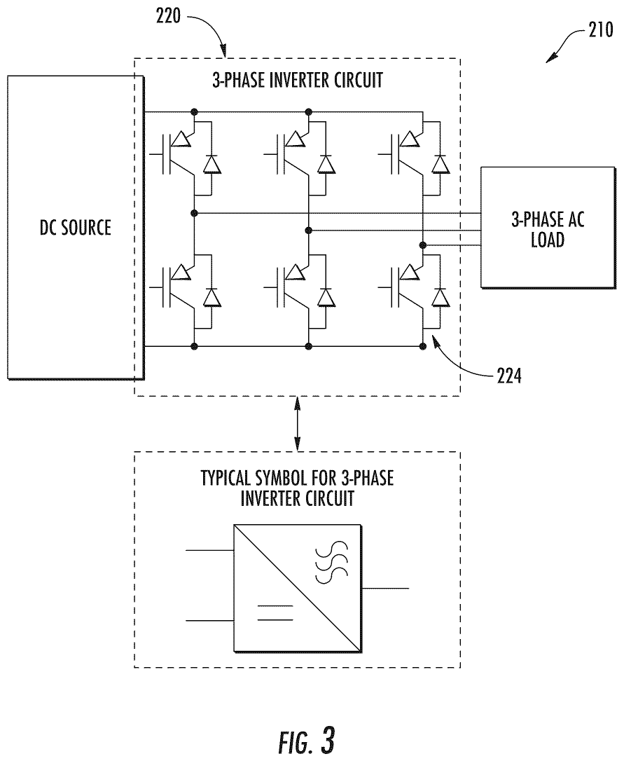

Referring now to FIG. 3, a schematic view of an embodiment of an individual inverter, such as the line-side converter 222, suitable for use with the full power conversion system shown in FIG. 2, is illustrated. Accordingly, as shown in FIG. 3, wind turbine generators (e.g., wtgs), like other IBRs, connect to a three-phase AC load (such as the electrical grid 212 of FIG. 2) via an inverter. Furthermore, as shown, the generator 118 is represented as a DC source. Thus, in embodiments, it should be understood that there are several forms of AC-DC converters, e.g., multi-level, and may also include several converters within the IBR, with all converters operating according to commands from the converter controller 262. In particular, as shown, the line-side converter 222 is a three-phase assembly with a plurality of semiconductor power switches 224 (such as insulated-gate bipolar transistors (IGBTs)). In other embodiments, the semiconductor power switches 224 may be any other type of switching devices now known or later developed in the art.

Accordingly, in an embodiment, the generator-side power converter 220 and the line-side power converter 222 may be configured in a three-phase, synchronous gating configuration including IGBT switching devices that operate as known in the art. In another embodiment, the generator-side power converter 220 and the line-side power converter 222 may be configured in a three-phase, pulse width modulation (PWM) gating configuration including IGBT switching devices that operate as known in the art. Alternatively, the generator-side power converter 220 and the line-side power converter 222 have any configuration using any switching devices that facilitate operation of power conversion system 200 as described herein.

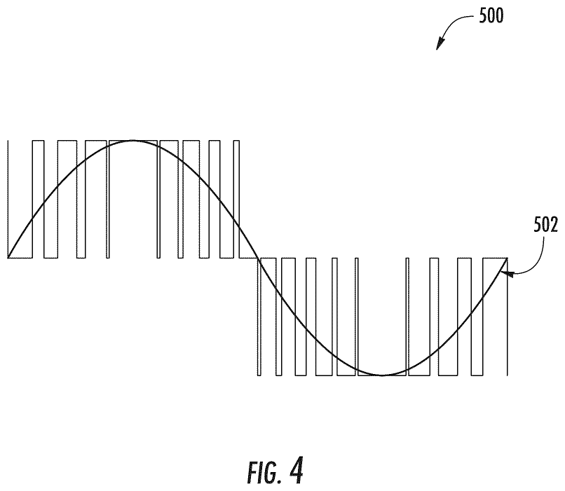

Referring now to FIG. 4, the generator-side power converter 220 and/or the line-side converter 222 as shown in FIGS. 2 and 3 have a voltage waveform 500 (also referred to herein as a pulse pattern). In such embodiments, the voltage waveform 500 is the actual voltage at the converter AC terminals when the pulse pattern includes a fundamental-frequency component illustrated by the sinusoidal waveform 502. The pulse pattern includes distortion components as well-known in art. The frequency, magnitude, and phase of the distortion components are a function of the switching times.

Moreover, in an embodiment, there are several means to creating the switching times of the voltage waveform 500, all of which are designed to cause the voltage of the generator-side power converter 220 and/or the line-side converter 222 to match the commands created by higher-level control functions, e.g., current regulators and others. In certain embodiments, the switching times are defined by the gating logic, such as pulse-width modulation (PWM) or synchronous gating.

In one embodiment, for example, PWM is used, whereby the gating times are established at a fixed rate based upon the instantaneous voltage magnitude desired within the next switching interval. In this example, the switching rate is significantly faster than the frequency of the grid, e.g., switching rates of several kHz are used whereas the grid frequency is either 60 Hz or 50 Hz.

Another approach is synchronous gating, whereby the switching times are based upon the angle reference provided by the phase-locked loop that is synchronized to the fundamental-frequency component of positive-sequence voltage measured at the bus. With synchronous gating, a pulse pattern is predetermined by calculation and programmed into the gating control. The pulse patterns are determined in a manner that minimizes selected harmonics. A benefit of synchronous gating versus PWM is to enable slower device switching rates than would be needed with a PWM approach

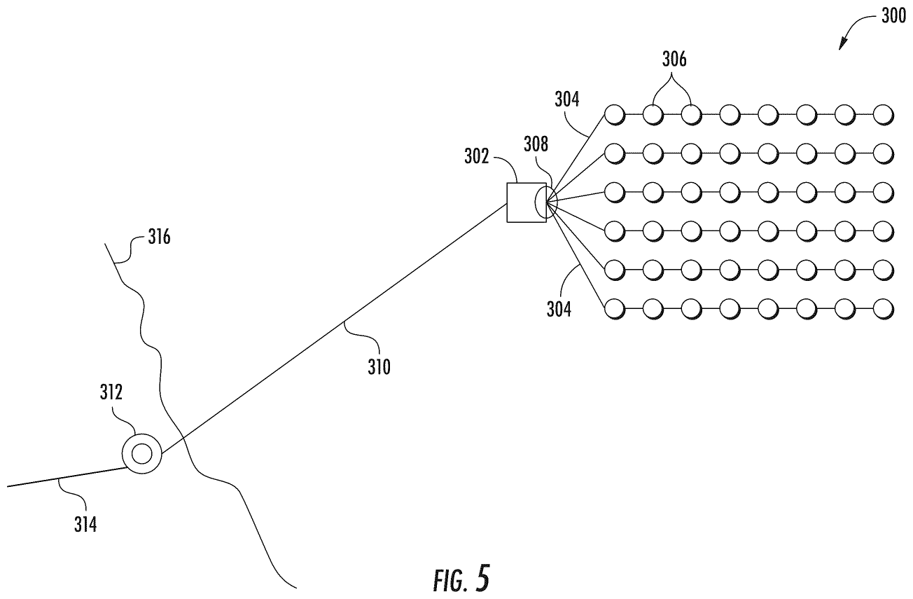

Referring now to FIG. 5, a schematic diagram of an embodiment of an offshore wind farm 300 is illustrated according to the present disclosure. As shown, the wind farm 300 includes a substation 302 at a common connection point 308. Further, as shown, in an embodiment, the wind farm 300 includes one or more wind farm strings 304 in parallel connected to the common connection point, and including a plurality of wind turbines 306. Wind farm strings 304 may also be called “lines” or “feeders”. One or more of the wind farm strings 304 may include a wind turbine, such as wind turbine 100 as described herein. In the illustrated embodiment, all strings 304 have the same length and the same number of wind turbines 306. In further embodiments, however, it should be understood that the strings 304 may also have different lengths (and thus different capacitances), and different numbers of wind turbines 306.

In additional embodiments, it should also be understood that although the strings 304 are depicted as being substantially parallel to each other, the strings 304 may be arranged in a variety of ways depending on the lay-out of the wind farm 300. For example, in an embodiment, the strings 304 may extend radially away from the common connection point 308.

Still referring to FIG. 5, as mentioned, the wind farm 300 may be an offshore wind farm. Further, the substation 302 may include a high voltage transformer, and may be connected to a high voltage transmission line 310, e.g., a HVAC or HVDC transmission line. Such a high voltage transmission line may be several kilometers long, e.g., 20 km, 70 km or more. The high voltage transmission line 310 may be connected to a point of common coupling (PPC) 312 with the mainland electrical grid 314. Reference sign 316 is representative of a coastline.

Accordingly, in an embodiment, an objective of the present disclosure is to have different switching times on adjacent generators 254 of a string 304 so that selected harmonics of the voltage will be 180 degrees out of phase. This will result in currents at those harmonics entering the string 304 at one connection and being extracted at the connection point of the adjacent generator 254, thereby not entering the substation with resultant distortion of the voltage at the substation. This is generally referred to as “interleaving”. As used herein, interleaving is a well-known approach to cancel net harmonics from multiple converters. For example, interleaving is widely used within converter-based systems when multiple converters are included, such as explained in U.S. Pat. No. 7,944,068 entitled “Optimizing converter protection for wind turbine generators” filed on Jun. 30, 2008, which is incorporated herein by reference in its entirety.

However, in the present disclosure, the difference in gate timing must be enforced in some manner. Prior art systems utilize communication between controllers to accomplish this function. However, the present disclosure accomplishes such interleaving without turbine-to-turbine communication. In particular, systems and methods of the present disclosure utilize voltage measured at the inverter-based resource to set the timing of the gating logic. This voltage typically will be very similar between adjacent inverter-based resources on a string, for example string 304. Thereby, the voltage can be used to determine reference time for the gating logic to attain effective interleaving.

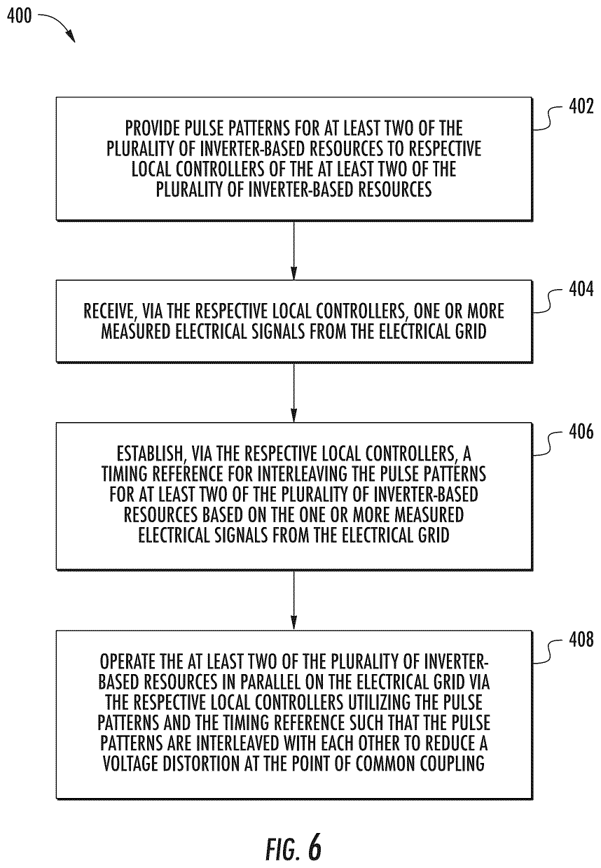

In an embodiment, and referring now to FIG. 6, a flow diagram of an illustrative method 400 for operating a plurality of inverter-based resources connected to an electrical grid at a point of common coupling in accordance with some embodiments of the present disclosure is illustrated. The flow diagrams and methods described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

As shown at (402), the method 400 includes providing pulse patterns for at least two of the plurality of inverter-based resources to respective local controllers of the at least two of the plurality of inverter-based resources. In an embodiment, for example, the pulse patterns may be determined offline, e.g., at commissioning of the inverter-based resources, and provided to the local turbine controllers 202 at installation as well as at any time during operation of the wind farm 300. In particular embodiments, for example, the pulse patterns for the inverter-based resources may be determined based on one or more selected harmonics. The selected harmonic(s) may include, for example, a combination of a magnitude and a phase angle with respect to a fundamental-frequency voltage.

Thus, in certain embodiments, the method 400 may further include storing the pulse patterns for the at least two of the plurality of inverter-based resources in respective local controllers (such as turbine controller 202) of the at least two of the plurality of inverter-based resources.

As shown at (404), the method 400 includes receiving, via the respective local controllers, one or more measured electrical signals from the electrical grid. The electrical signals may include, for example, voltage, current, or combinations or functions thereof. Thus, as shown at (406), the method 400 includes establishing, via the respective local controllers, a timing reference for interleaving the pulse patterns for at least two of the plurality of inverter-based resources based on the one or more measured electrical signals from the electrical grid.

Moreover, as shown at (408), the method 400 includes operating the at least two of the plurality of inverter-based resources in parallel on the electrical grid via the respective local controllers utilizing the pulse patterns and the timing reference such that the pulse patterns are interleaved with each other to reduce a voltage distortion at the point of common coupling. In such embodiments, the inverter-based resources may be operated using synchronous gating or pulse width modulation.

Accordingly, in such embodiments, a net effect of the selected harmonic(s) cancel each other when the two inverter-based resources are operating on the electrical grid with the interleaved pulse patterns.

Accordingly, for methods of the present disclosure, the grid voltage provides the means of maintaining the individual inverter-based resources performing the desired interleaving function such that communication between the respective controllers is not needed or required. In particular, in an embodiment, the respective local controllers operate independently of each other to establish the timing reference for interleaving the pulse patterns and utilize only the one or more measured electrical signals without communicating to each other.

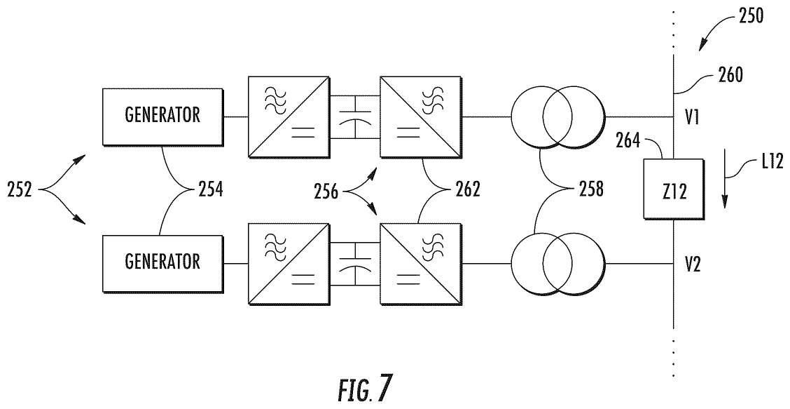

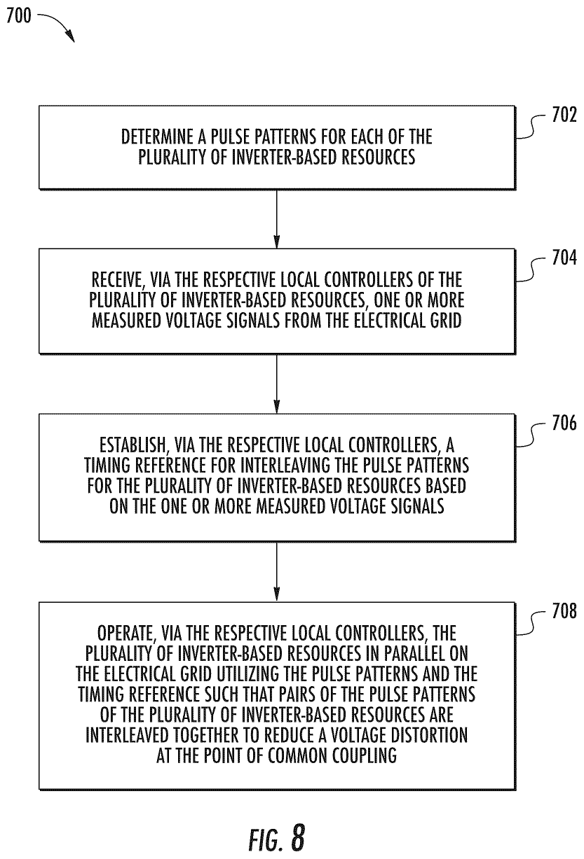

Referring now to FIG. 7, a schematic diagram of an embodiment of a string 250 of inverter-based resources 252 according to the present disclosure is illustrated. As shown, each inverter-based resource 252 includes a generator 254 and a back-back power conversion system 256 coupled via a transformer 258 to a high-voltage bus 260 of the string 250. However, FIG. 8 is provided to show a method of attaining the desired timing reference even if there is some impedance (e.g., Z12) between the connection points. In such embodiments, establishing the desired timing reference requires measuring current flow (e.g., 112) on the portion of string 250 between the adjacent generators 254. This current flow can be sensed within the switchgear assembly of each individual inverter-based resource so no communication is needed between controllers.

Referring now to FIG. 8, a flow diagram of another illustrative method 700 for operating a plurality of inverter-based resources connected to an electrical grid at a point of common coupling in accordance with some embodiments of the present disclosure is illustrated. As shown at (702), the method 700 includes determining a pulse pattern for each of the plurality of inverter-based resources. As shown at (704), the method 700 includes receiving, via respective local controllers of the plurality of inverter-based resources, one or more measured voltage signals from the electrical grid. As shown at (706), the method 700 includes establishing, via the respective local controllers, a timing reference for interleaving the pulse patterns for the plurality of inverter-based resources based on the one or more measured voltage signals. Thus, as shown at (708), the method 700 includes operating, via the respective local controllers, the plurality of inverter-based resources in parallel on the electrical grid utilizing the pulse patterns and the timing reference such that pairs of the pulse patterns of the plurality of inverter-based resources are interleaved together to reduce a voltage distortion at the point of common coupling.

Even though in the present disclosure, the wind turbines and wind farms are generally illustrated and explained to be offshore wind turbines and wind farms, it should be clear that the same or similar arrangement can be used onshore as well.

Further aspects of the invention are provided by the subject matter of the following clauses:

Clause 1. A method for operating a plurality of inverter-based resources connected to an electrical grid at a point of common coupling, the method comprising:
providing pulse patterns for at least two of the plurality of inverter-based resources to respective local controllers of the at least two of the plurality of inverter-based resources;
receiving, via the respective local controllers, one or more measured electrical signals from the electrical grid;
establishing, via the respective local controllers, a timing reference for interleaving the pulse patterns for the at least two of the plurality of inverter-based resources based on the one or more measured electrical signals from the electrical grid; and
operating the at least two of the plurality of inverter-based resources in parallel on the electrical grid via the respective local controllers utilizing the pulse patterns and the timing reference such that the pulse patterns are interleaved with each other to reduce a voltage distortion at the point of common coupling.

Clause 2. The method of clause 1, wherein providing the pulse patterns for the at least two of the plurality of inverter-based resources further comprises: determining the pulse patterns for the at least two of the plurality of inverter-based resources based on one or more selected harmonics comprising a combination of a magnitude and a phase angle with respect to a fundamental-frequency voltage such that a net effect of the one or more selected harmonics cancel each other when the at least two of the plurality of inverter-based resources are operating on the electrical grid.

Clause 3. The method of clause 2, wherein the pulse patterns comprises a first pulse pattern having a first amplitude of a selected harmonic and a second pulse pattern having a second amplitude of the selected harmonic, wherein the first and second amplitudes of the selected harmonic are equal.

Clause 4. The method of clause 3, wherein the first pulse pattern has a first phase angle and the second pulse pattern has a second phase angle, the first phase angle being shifted from the second phase angle by 180 degrees.

Clause 5. The method of any of the preceding clauses, wherein operating the at least two of the plurality of inverter-based resources in parallel on the electrical grid further comprises utilizing synchronous gating.

Clause 6. The method of any of the preceding clauses, wherein operating the at least two of the plurality of inverter-based resources in parallel on the electrical grid further comprises utilizing pulse width modulation.

Clause 7. The method of any of the preceding clauses, further comprising:
predetermining the pulse patterns for the at least two of the plurality of inverter-based resources offline; and
storing the pulse patterns for the at least two of the plurality of inverter-based resources in the respective local controllers of the at least two of the plurality of inverter-based resources.

Clause 8. The method of any of the preceding clauses, wherein the respective local controllers operate independently of each other to establish the timing reference for interleaving the pulse patterns and utilize only the one or more measured electrical signals without communicating to each other.

Clause 9. The method of any of the preceding clauses, wherein one or more of the plurality of inverter-based resources are wind turbines.

Clause 10. A wind farm connected to an electrical grid, comprising:
a plurality of wind turbines connected in parallel to the electrical grid at a point of common coupling;
a plurality of local controllers, each of the plurality of wind turbines being controlled by one of the plurality of local controllers, each of the plurality of local controllers comprising a pulse pattern programmed therein, the plurality of local controllers configured to perform one or more operations, the one or more operations comprising:
   receiving one or more measured electrical signals from the electrical grid;
   establishing a timing reference for interleaving the pulse patterns for the at least two of the wind turbines based on the one or more measured electrical signals from the electrical grid; and
   operating the at least two of the wind turbines in parallel on the electrical grid utilizing the pulse patterns and the timing reference such that the pulse patterns are interleaved with each other to reduce a voltage distortion at the point of common coupling.

Clause 11. The wind farm of clause 10, wherein the pulse pattern for each of the plurality of wind turbines is predetermined based on one or more selected harmonics comprising a combination of a magnitude and a phase angle with respect to a fundamental-frequency voltage such that a net effect of the one or more selected harmonics cancel each other when the at least two of the plurality of wind turbines are operating on the electrical grid.

Clause 12. A method for operating a plurality of inverter-based resources connected to an electrical grid at a point of common coupling, the method comprising:
determining a pulse pattern for each of the plurality of inverter-based resources;
receiving, via respective local controllers of the plurality of inverter-based resources, one or more measured voltage signals from the electrical grid;
establishing, via the respective local controllers, a timing reference for interleaving the pulse patterns for the plurality of inverter-based resources based on the one or more measured voltage signals; and
operating, via the respective local controllers, the plurality of inverter-based resources in parallel on the electrical grid utilizing the pulse patterns and the timing reference such that pairs of the pulse patterns of the plurality of inverter-based resources are interleaved together to reduce a voltage distortion at the point of common coupling.

Clause 13. The method of clause 12, wherein determining the pulse pattern for each of the plurality of inverter-based resources further comprises: determining the pulse pattern for each of the plurality of inverter-based resources based on one or more selected harmonics comprising a combination of a magnitude and a phase angle with respect to a fundamental-frequency voltage such that a net effect of the one or more selected harmonics cancel each other when the at least two of the plurality of inverter-based resources are operating on the electrical grid.

Clause 14. The method of clause 13, wherein an amplitude of the pairs of the pulse patterns are equal.

Clause 15. The method of clause 14, wherein a phase angle of the pairs of the pulse patterns shifted from each other as a function of a number of the plurality of inverter-based resources.

Clause 16. The method of clauses 12-15, wherein determining the pulse patterns for each of the plurality of inverter-based resources further comprises: predetermining the pulse patterns for each of the plurality of inverter-based resources offline.

Clause 17. The method of clauses 12-16, wherein operating the at least two of the plurality of inverter-based resources in parallel on the electrical grid further comprises utilizing synchronous gating.

Clause 18. The method of clauses 12-17, wherein operating the at least two of the plurality of inverter-based resources in parallel on the electrical grid further comprises utilizing pulse width modulation.

Clause 19. The method of clauses 12-18, wherein the respective local controllers operate independently of each other to establish the timing reference for interleaving the pulse patterns and utilize only the one or more measured electrical signals without communicating to each other.

Clause 20. The method of clauses 12-19, wherein one or more of the plurality of inverter-based resources are wind turbines.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a plurality of inverter-based resources connected to an electrical grid at a point of common coupling, the method comprising:
providing pulse patterns for at least two of the plurality of inverter-based resources to respective local controllers of the at least two of the plurality of inverter-based resources;
receiving, via the respective local controllers, one or more measured electrical signals from the electrical grid;
establishing, via the respective local controllers, a timing reference for interleaving the pulse patterns for the at least two of the plurality of inverter-based resources based on the one or more measured electrical signals from the electrical grid; and
operating the at least two of the plurality of inverter-based resources in parallel on the electrical grid via the respective local controllers utilizing the pulse patterns and the timing reference such that the pulse patterns are interleaved with each other to reduce a voltage distortion at the point of common coupling.

2. The method of claim 1, wherein providing the pulse patterns for the at least two of the plurality of inverter-based resources further comprises:
determining the pulse patterns for the at least two of the plurality of inverter-based resources based on one or more selected harmonics comprising a combination of a magnitude and a phase angle with respect to a fundamental-frequency voltage such that a net effect of the one or more selected harmonics cancel each other when the at least two of the plurality of inverter-based resources are operating on the electrical grid.

3. The method of claim 2, wherein the pulse patterns comprises a first pulse pattern having a first amplitude of a selected harmonic and a second pulse pattern having a second amplitude of the selected harmonic, wherein the first and second amplitudes of the selected harmonic are equal.

4. The method of claim 3, wherein the first pulse pattern has a first phase angle and the second pulse pattern has a second phase angle, the first phase angle being shifted from the second phase angle by 180 degrees.

5. The method of claim 1, wherein operating the at least two of the plurality of inverter-based resources in parallel on the electrical grid further comprises utilizing synchronous gating.

6. The method of claim 1, wherein operating the at least two of the plurality of inverter-based resources in parallel on the electrical grid further comprises utilizing pulse width modulation.

7. The method of claim 1, further comprising:
predetermining the pulse patterns for the at least two of the plurality of inverter-based resources offline; and
storing the pulse patterns for the at least two of the plurality of inverter-based resources in the respective local controllers of the at least two of the plurality of inverter-based resources.

8. The method of claim 1, wherein the respective local controllers operate independently of each other to establish the timing reference for interleaving the pulse patterns and utilize only the one or more measured electrical signals without communicating to each other.

9. The method of claim 1, wherein one or more of the plurality of inverter-based resources are wind turbines.

10. A wind farm connected to an electrical grid, comprising:
a plurality of wind turbines connected in parallel to the electrical grid at a point of common coupling;
a plurality of local controllers, each of the plurality of wind turbines being controlled by one of the plurality of local controllers, each of the plurality of local controllers comprising a pulse pattern programmed therein, the plurality of local controllers configured to perform one or more operations, the one or more operations comprising:
receiving one or more measured electrical signals from the electrical grid;
establishing a timing reference for interleaving the pulse patterns for the at least two of the wind turbines based on the one or more measured electrical signals from the electrical grid; and
operating the at least two of the wind turbines in parallel on the electrical grid utilizing the pulse patterns and the timing reference such that the pulse patterns are interleaved with each other to reduce a voltage distortion at the point of common coupling.

11. The wind farm of claim 10, wherein the pulse pattern for each of the plurality of wind turbines is predetermined based on one or more selected harmonics comprising a combination of a magnitude and a phase angle with respect to a fundamental-frequency voltage such that a net effect of the one or more selected harmonics cancel each other when the at least two of the plurality of wind turbines are operating on the electrical grid.

12. A method for operating a plurality of inverter-based resources connected to an electrical grid at a point of common coupling, the method comprising:
determining a pulse pattern for each of the plurality of inverter-based resources;
receiving, via respective local controllers of the plurality of inverter-based resources, one or more measured voltage signals from the electrical grid;
establishing, via the respective local controllers, a timing reference for interleaving the pulse patterns for the plurality of inverter-based resources based on the one or more measured voltage signals; and
operating, via the respective local controllers, the plurality of inverter-based resources in parallel on the electrical grid utilizing the pulse patterns and the timing reference such that pairs of the pulse patterns of the plurality of inverter-based resources are interleaved together to reduce a voltage distortion at the point of common coupling.

13. The method of claim 12, wherein determining the pulse pattern for each of the plurality of inverter-based resources further comprises:
determining the pulse pattern for each of the plurality of inverter-based resources based on one or more selected harmonics comprising a combination of a magnitude and a phase angle with respect to a fundamental-frequency voltage such that a net effect of the one or more selected harmonics cancel each other when the at least two of the plurality of inverter-based resources are operating on the electrical grid.

14. The method of claim 13, wherein an amplitude of the pairs of the pulse patterns are equal.

15. The method of claim 14, wherein a phase angle of the pairs of the pulse patterns shifted from each other as a function of a number of the plurality of inverter-based resources.

16. The method of claim 12, wherein determining the pulse patterns for each of the plurality of inverter-based resources further comprises:
predetermining the pulse patterns for each of the plurality of inverter-based resources offline.

17. The method of claim 12, wherein operating the at least two of the plurality of inverter-based resources in parallel on the electrical grid further comprises utilizing synchronous gating.

18. The method of claim 12, wherein operating the at least two of the plurality of inverter-based resources in parallel on the electrical grid further comprises utilizing pulse width modulation.

19. The method of claim 12, wherein the respective local controllers operate independently of each other to establish the timing reference for interleaving the pulse patterns and utilize only the one or more measured electrical signals without communicating to each other.

20. The method of claim 12, wherein one or more of the plurality of inverter-based resources are wind turbines.
